(19) United States
(12) Patent Application Publication
(10) Pub. No.: US 2023/0128403 A1
(43) Pub. Date: Apr. 27, 2023

(54) OPERATION DEVICE

(71) Applicant: KABUSHIKI KAISHA TOKAI-RIKA-DENKI-SEISAKUSHO, Niwa-gun, Aichi (JP)

(72) Inventors: Naofumi KATO, Niwa-gun, Aichi (JP); Masanori KOSUGI, Niwa-gun, Aichi (JP); Hitoshi MURAKI, Niwa-gun, Aichi (JP); Tetsuya EGAWA, Niwa-gun, Aichi (JP)

(21) Appl. No.: 17/798,695

(22) PCT Filed: Dec. 15, 2020
(86) PCT No.: PCT/JP2020/046751

§ 371 Date: Aug. 10, 2022

(30) Foreign Application Priority Data
Feb. 14, 2020 (JP) 2020-023424

(51) Int. Cl. B62D 1/14; B62D 1/04; G05G 1/01; G05G 1/04; G05G 1/08; G05G 9/047

(52) U.S. Cl. CPC B62D 1/14; B62D 1/04; G05G 1/01; G05G 1/04; G05G 1/08; G05G 9/047

(57) ABSTRACT

An operation device has a first displacement portion that is displaceable by being operated by an occupant of a vehicle, and a second displacement portion that is supported at the first displacement portion and that is displaceable with respect to the first displacement portion by being operated by an occupant of the vehicle. Further, the operation device has a first locking portion and a second locking portion that, at a time when a mode of the vehicle is a first mode, permit displacement of the first displacement portion and restrict displacement of the second displacement portion with respect to the first displacement portion, and, at a time when the mode of the vehicle is a second mode, restrict displacement of the first displacement portion and permit displacement of the second displacement portion with respect to the first displacement portion.

### TECHNICAL FIELD

The present invention relates to an operation device.

### BACKGROUND ART

Japanese Patent Application Laid-Open (JP-A) No. 2009-107390 discloses a vehicle that can, in addition to being moved in directions of straight traveling (toward the front side and the rear side), can also be moved in the direction orthogonal to the directions of straight traveling. Vehicles that can travel in plural traveling modes, such as the vehicle disclosed in the aforementioned publication, necessitate an operation device that can correspond to the plural traveling modes.

Further, vehicles that have plural transmission modes also require an operation device that can correspond to the plural transmission modes.

### SUMMARY OF INVENTION

### Technical Problem

In view of the above-described circumstances, an object of the present invention is to provide an operation device that can correspond to plural modes.

### Solution to Problem

An operation device relating to a first aspect comprises: a first displacement portion that is displaceable by being operated by an occupant of a vehicle; a second displacement portion that is supported at the first displacement portion, and is displaceable with respect to the first displacement portion by being operated by an occupant of the vehicle, and a locking portion that, at a time when a mode of the vehicle is a first mode, permits displacement of the first displacement portion and restricts displacement of the second displacement portion with respect to the first displacement portion, and, at a time when the mode of the vehicle is a second mode, restricts displacement of the first displacement portion and permits displacement of the second displacement portion with respect to the first displacement portion.

In an operation device relating to a second aspect, in the operation device of the first aspect, the first displacement portion is rotatably supported, and the second displacement portion is tiltably supported at the first displacement portion.

In an operation device relating to a third aspect, in the operation device of the first aspect, the first displacement portion is tiltably supported, and the second displacement portion is tiltably supported at the first displacement portion.

In an operation device relating to a fourth aspect, in the operation device of any one of the first aspect through the third aspect, the second displacement portion is rotatably supported at the first displacement portion.

### Advantageous Effects of Invention

In the operation device relating to the first aspect, at the time when the mode of the vehicle is the first mode, the locking portion permits displacement of the first displacement portion, and restricts displacement of the second displacement portion with respect to the first displacement portion. In this state, an occupant of the vehicle can carry out operations that displace the first displacement portion. At the time when the mode of the vehicle is the second mode, the locking portion restricts displacement of the first displacement portion, and permits displacement of the second displacement portion with respect to the first displacement portion. In this state, an occupant of the vehicle can carry out operations that displace the second displacement portion with respect to the first displacement portion. In this way, in the operation device relating to the first aspect, operations corresponding to the first mode and the second mode of the vehicle can be carried out.

In the operation device relating to the second aspect, at the time when the mode of the vehicle is the first mode, the locking portion permits rotation of the first displacement portion, and restricts tilting of the second displacement portion with respect to the first displacement portion. In this state, an occupant of the vehicle can carry out operations that rotate the first displacement portion. At the time when the mode of the vehicle is the second mode, the locking portion restricts rotation of the first displacement portion, and permits tilting of the second displacement portion with respect to the first displacement portion. In this state, an occupant of the vehicle can carry out operations that tilt the second displacement portion with respect to the first displacement portion. In this way, in the operation device relating to the second aspect, operations corresponding to the first mode and the second mode of the vehicle can be carried out.

In the operation device relating to the third aspect, at the time when the mode of the vehicle is the first mode, the locking portion permits tilting of the first displacement portion, and restricts tilting of the second displacement portion with respect to the first displacement portion. In this state, an occupant of the vehicle can carry out operations that tilt the first displacement portion. At the time when the mode of the vehicle is the second mode, the locking portion restricts tilting of the first displacement portion, and permits tilting of the second displacement portion with respect to the first displacement portion. In this state, an occupant of the vehicle can carry out operations that tilt the second displacement portion with respect to the first displacement portion. In this way, in the operation device relating to the third aspect, operations corresponding to the first mode and the second mode of the vehicle can be carried out.

In the operation device relating to the fourth aspect, at the time when the mode of the vehicle is the first mode, the locking portion permits displacement of the first displacement portion, and restricts rotation of the second displacement portion with respect to the first displacement portion. In this state, an occupant of the vehicle can carry out operations that displace the first displacement portion. At the time when the mode of the vehicle is the second mode, the locking portion restricts displacement of the first displacement portion, and permits rotation of the second displacement portion with respect to the first displacement portion. In this state, an occupant of the vehicle can carry out operations that rotate the second displacement portion with respect to the first displacement portion. In this way, in the operation device relating to the fourth aspect, operations corresponding to the first mode and the second mode of the vehicle can be carried out.

### BRIEF DESCRIPTION OF DRAWINGS

FIG. 1 is a front view illustrating an operation device relating to a first embodiment.

FIG. 2 is a front view illustrating the operation device relating to the first embodiment, and illustrates a state in which the operation device is operated in a state in which a vehicle is in a first mode.

FIG. 3 is a front view illustrating the operation device relating to the first embodiment, and illustrates a state in which the operation device is operated in a state in which the vehicle is in a second mode.

FIG. 4 is a schematic drawing illustrating the vehicle at the time when the operation device is operated in the state in which the vehicle is in the first mode.

FIG. 5 is a schematic drawing illustrating the vehicle at the time when the operation device is operated in the state in which the vehicle is in the second mode.

FIG. 6 is a perspective view illustrating an operation device relating to a second embodiment, and illustrates a state in which the operation device is operated in a state in which the vehicle is in the second mode.

FIG. 7 is a schematic drawing illustrating the vehicle at the time when the operation device is operated in the state in which the vehicle is in the second mode.

FIG. 8 is a side view illustrating an operation device relating to a third embodiment, and illustrates a state in which the operation device is operated in a state in which the vehicle is in the first mode.

FIG. 9 is a side view illustrating the operation device relating to the third embodiment, and illustrates a state in which the operation device is operated in a state in which the vehicle is in the second mode.

FIG. 10 is a perspective view illustrating an operation device relating to a fourth embodiment, and illustrates a state in which the operation device is operated in a state in which the vehicle is in the second mode.

### DESCRIPTION OF EMBODIMENTS

### Operation Device 10 Relating to First Embodiment

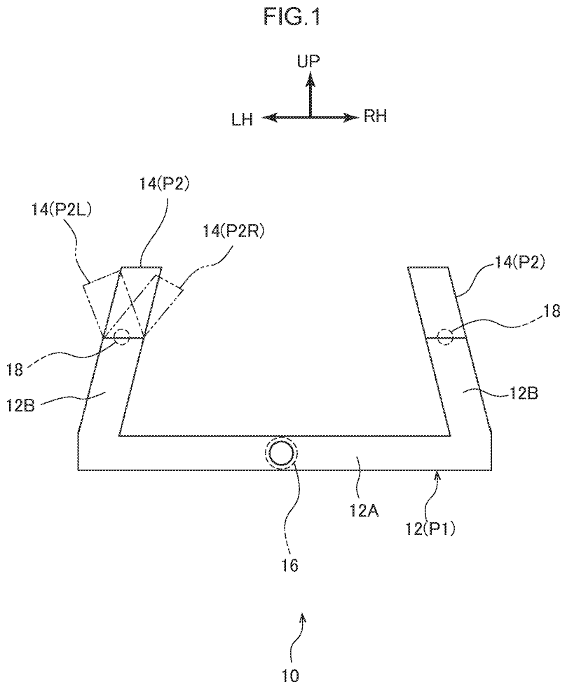

An operation device 10 relating to a first embodiment of the present invention is described by using FIG. 1 through FIG. 3. Note that, when description is given by referring to the longitudinal, left-right and vertical directions in the following explanation, they indicate the longitudinal direction of the vehicle, the left-right direction of the vehicle (the transverse direction of the vehicle), and the vertical direction of the vehicle. Further, arrow FR that is shown appropriately in the respective drawings indicates the frontward direction of the vehicle, arrow RR indicates the rearward direction of the vehicle, arrow UP indicates the upward direction of the vehicle, arrow RH indicates the rightward direction of the vehicle, and arrow LH indicates the leftward direction of the vehicle, respectively.

As illustrated in FIG. 1, the operation device 10 of the present embodiment has a first displacement portion 12 that can rotate by being operated by an occupant of the vehicle, and a pair of left and right second displacement portions 14 that are tiltably supported at the first displacement portion 12. Further, the operation device 10 has a first locking portion 16 that serves as a locking portion and that permits or restricts rotation of the first displacement portion 12, and second locking portions 18 that serve as locking portions and permit or restrict tilting of the second displacement portions 14 with respect to the first displacement portion 12.

The first displacement portion 12 has a proximal portion 12A that extends in the left-right direction and whose left-right direction central portion is rotatably supported, and gripped portions 12B that extend from the left-side end portion and the right-side end portion of the proximal portion 12A toward the upper side respectively and that are inclined toward the left-right direction central portion side of the proximal portion 12A while heading toward the upper side. Further, the first displacement portion 12 can be rotated in a state in which the occupant of the vehicle grips the left and right gripped portions 12B. Note that the position of the first displacement portion 12, in the state in which the proximal portion 12A is parallel to the left-right direction, is called neutral position P1.

The one (the left-side) second displacement portion 14 is supported at the end portion, which is at the side opposite the proximal portion 12A, of the left-side gripped portion 12B of the first displacement portion 12 via an unillustrated tilting mechanism so as to be able to tilt in a predetermined range in the left-right direction. Note that, in FIG. 1, the state in which the second displacement portion 14 is disposed at neutral position P2 is illustrated by the solid lines, and position P2L, at which the second displacement portion 14 is tilted furthest toward the left side, and position P2R, at which the second displacement portion 14 is tilted furthest toward the right side, are respectively illustrated by the two-dot chain lines.

The another (the right-side) second displacement portion 14 is supported at the end portion, which is at the side opposite the proximal portion 12A, of the right-side gripped portion 12B of the first displacement portion 12 via an unillustrated tilting mechanism so as to be able to tilt in a predetermined range in the left-right direction. Note that the second displacement portion 14 at the right side can tilt in the left-right direction in a range that is similar to that of the second displacement portion 14 at the left side.

The first locking portion 16 is, as an example, provided at the left-right direction central portion of the proximal portion 12A of the first displacement portion 12 (at the portion of the proximal portion 12A that is rotatably supported). This first locking portion 16 can be switched to two states that are a permitting state and a restricting state by, as an example, the electrification thereof being switched, or the like. Further, at the time when the first locking portion 16 is in the permitting state, rotation of the first displacement portion 12 is permitted. On the other hand, at the time when the first locking portion 16 is in the restricting state, rotation of the first displacement portion 12 is restricted. Note that the switching between the permitting state and the restricting state of the first locking portion 16 may be switching by a mechanical structure and not an electrical structure.

The second locking portions 18 are, as an example, provided integrally with the tilting mechanisms that can tilt the second displacement portions 14 with respect to the first displacement portion 12. These second locking portions 18 can be switched to two states that are a permitting state and a restricting state by, as an example, the electrification thereof being switched, or the like. Further, at the time when the second locking portions 18 are in the permitting states, tilting of the second displacement portions 14 with respect to the first displacement portion 12 is permitted. On the other hand, at the time when the second locking portions 18 are in the restricting states, tilting of the second displacement portions 14 with respect to the first displacement portion 12 is restricted. Note that the switching between the permitting states and the restricting states of the second locking portions 18 may be switching by a mechanical structure and not an electrical structure.

### Operation and Effects of Present Embodiment

Operation and effects of the present embodiment are described next.

As an example, the above-described operation device 10 relating to the present embodiment can be applied to the following operation.

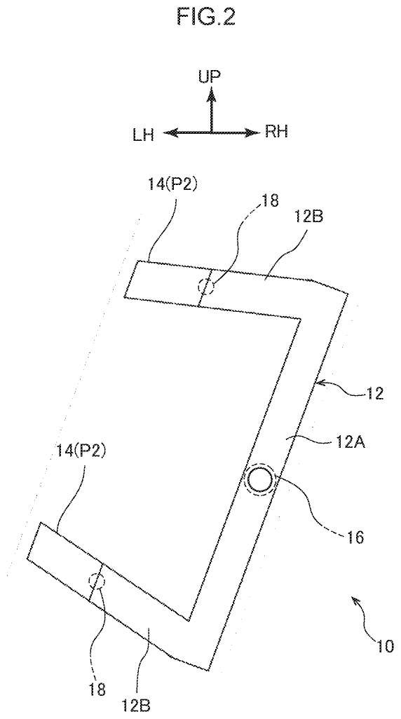

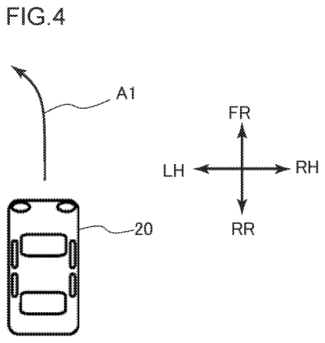

As illustrated in FIG. 2, in a case in which the mode of the vehicle is a first mode, the first locking portion 16 is in the permitting state, and the second locking portions 18 are in restricting states. Here, the first mode is a “usual steering mode”, and, in this usual steering mode, the vehicle 20 that is traveling as usual can be turned toward the left side or the right side. In the first mode, rotation of the first displacement portion 12 is permitted, and tilting of the second displacement portions 14 from the neutral positions P2 is restricted. Further, in a case in which the mode of the vehicle is the first mode, the occupant of the vehicle can rotate the first displacement portion 12 in a state of gripping the pair of gripped portions 12B of the first displacement portion 12 by his/her both hands, respectively. As an example, as illustrated in FIG. 4, the vehicle 20 that is straight traveling toward the front side can be turned toward the left side (the arrow A1 direction side) due to the first displacement portion 12 being rotated toward the left side. Note that, although not illustrated, the vehicle 20 that is straight traveling toward the front side can be turned toward the right side due to the first displacement portion 12 being rotated toward the right side.

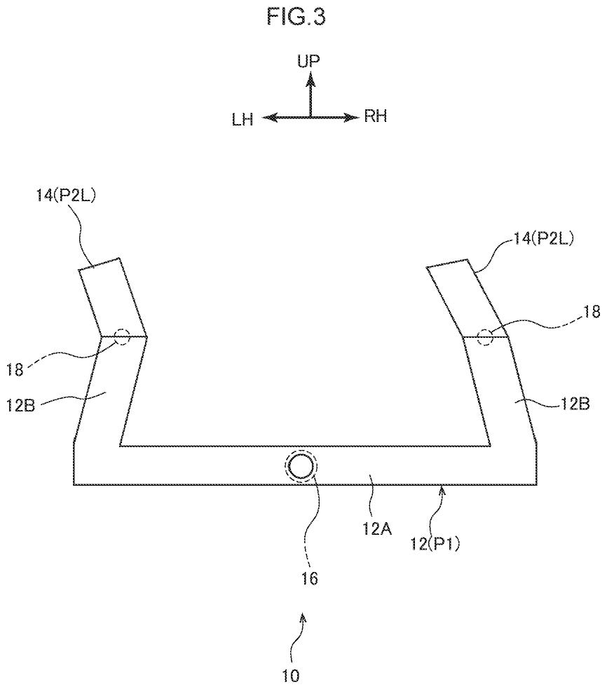

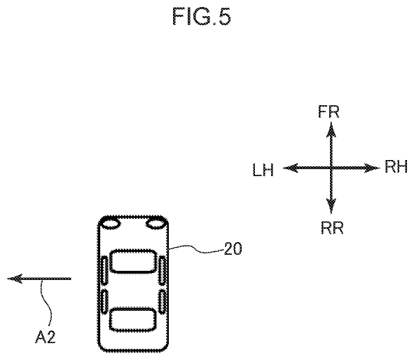

As illustrated in FIG. 3, in a case in which the mode of the vehicle is the second mode, the first locking portion 16 is in the restricting state, and the second locking portions 18 are in the permitting states. Here, the second mode is a “mode in which the vehicle 20 can move in a direction orthogonal to the straight traveling direction”. Note that the switching between the above-described first mode and second mode is switching by an unillustrated switching switch. In the second mode, rotation of the first displacement portion 12 from the neutral position P1 is restricted, and tilting of the second displacement portions 14 with respect to the first displacement portion 12 is permitted. Further, in a case in which the mode of the vehicle is the second mode, the occupant of the vehicle can tilt the second displacement portions 14 with respect to the first displacement portion 12 in a state of gripping the pair of second displacement portions 14 by his/her both hands, respectively. As an example, as illustrated in FIG. 5, the vehicle 20 can be moved toward the left side (the arrow A2 direction side) that is a direction orthogonal to the longitudinal direction, due to the pair of second displacement portions 14 being simultaneously tilted toward the left side. Note that, although not illustrated, the vehicle 20 can be moved toward the right side that is a direction orthogonal to the longitudinal direction, due to the pair of second displacement portions 14 being simultaneously tilted toward the right side.

### Operation Device Relating to Second Embodiment

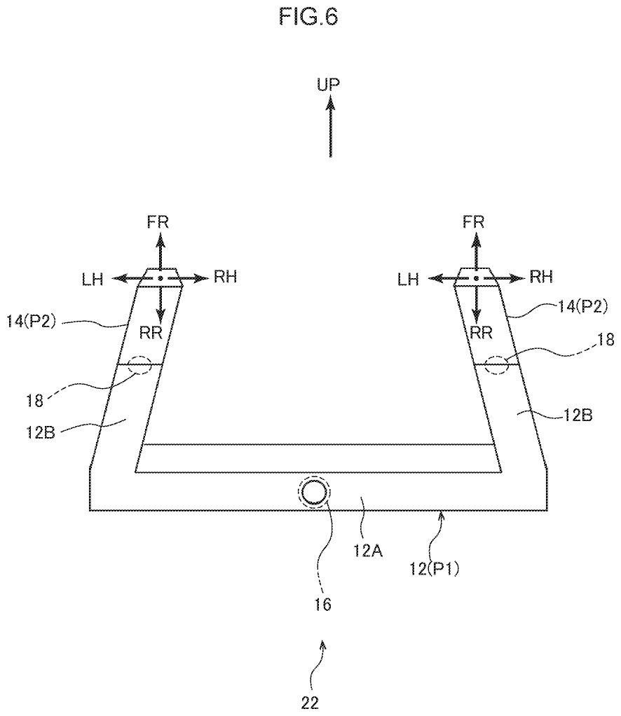

An operation device 22 relating to a second embodiment of the present invention is described next by using FIG. 6. Note that, at the operation device 22 relating to the second embodiment, members and portions corresponding to the operation device 10 relating to the above-described first embodiment are denoted by the same reference numerals as the members and portions corresponding to the operation device 10 relating to the first embodiment, and there are cases in which description thereof is omitted.

As illustrated in FIG. 6, at the operation device 22 of the present embodiment, the pair of left and right second displacement portions 14 are supported so as to be able to tilt in predetermined ranges in the left-right direction and in the longitudinal direction. In the operation device 22 of this structure, the following operation can be carried out in addition to the operations of the above-described operation device 10 relating to the first embodiment.

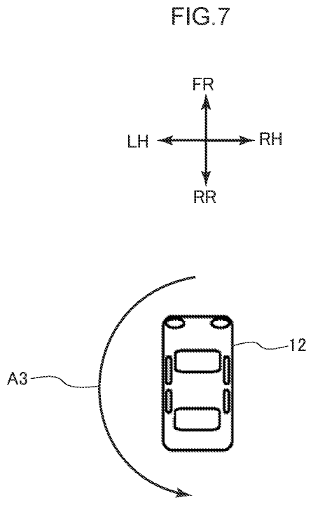

Specifically, in a case in which the mode of the vehicle is the second mode, due to the left-side second displacement portion 14 being tilted toward the rear side, and the right-side second displacement portion 14 being tilted toward the front side, as illustrated in FIG. 7, the vehicle 20 can be rotated counterclockwise (rotated in the arrow A3 direction) in a state in which the longitudinal position and the left-right position of the vehicle 20 hardly move at all. Note that, although not illustrated, due to the left-side second displacement portion 14 being tilted toward the front side, and the right-side second displacement portion 14 being tilted toward the rear side, the vehicle 20 can be rotated clockwise in a state in which the longitudinal position and the left-right position of the vehicle 20 hardly move at all.

### Operation Device Relating to Third Embodiment

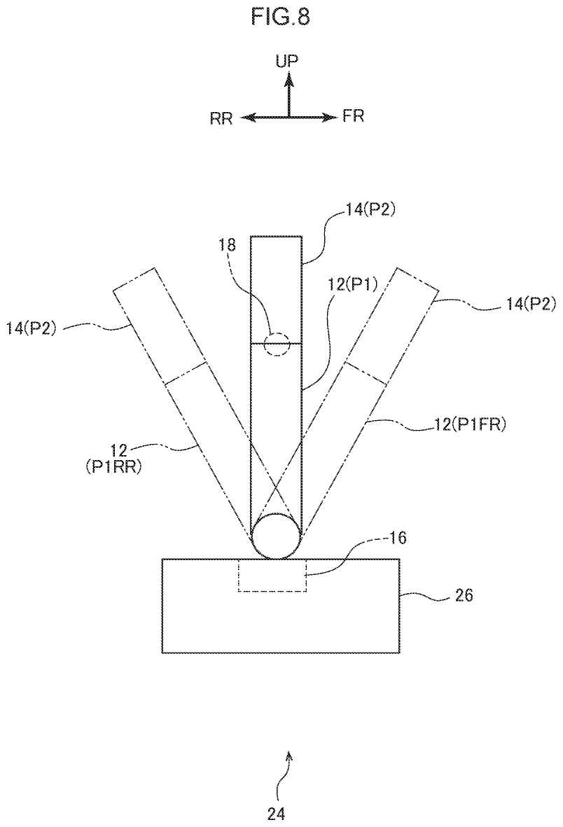

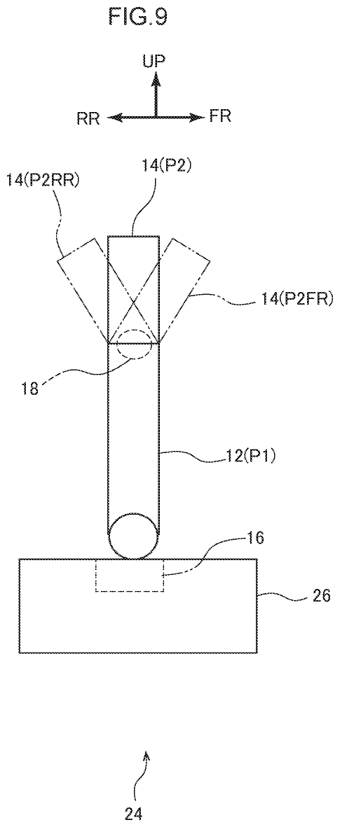

An operation device 24 relating to a third embodiment of the present invention is described next by using FIG. 8 and FIG. 9.

As illustrated in FIG. 8, the operation device 24 of the present embodiment has the first displacement portion 12 that can tilt by being operated by an occupant of the vehicle, and the second displacement portion 14 that is tiltably supported at the first displacement portion 12. Further, the operation device 24 has the first locking portion 16 that serves as a locking portion and that permits or restricts tilting of the first displacement portion 12, and the second locking portion 18 that serves as a locking portion and permits or restricts tilting of the second displacement portion 14 with respect to the first displacement portion 12.

The first displacement portion 12 is formed in the shape of a rod that extends in the vertical direction. The lower end portion of the first displacement portion 12 is supported at a base portion 26 that has an unillustrated tilting mechanism. The first displacement portion 12 can tilt in the longitudinal direction with respect to the base portion 26. Due thereto, the first displacement portion 12 can be tilted in the state in which the occupant of the vehicle grips the second displacement portion 14 that is described later. Note that the position of the first displacement portion 12 in the state in which the first displacement portion 12 is parallel to the vertical direction is called the neutral position P1. Further, in FIG. 8, the state in which the first displacement portion 12 is disposed at the neutral position P1 is illustrated by the solid lines, and position P1FR, at which the first displacement portion 12 is tilted furthest toward the front side, and position P1RR, at which the first displacement portion 12 is tilted furthest toward the rear side, are illustrated by the two-dot chain lines, respectively.

As illustrated in FIG. 9, the second displacement portion 14 is supported at the upper end portion of the first displacement portion 12 via an unillustrated tilting mechanism so as to be able to tilt within a predetermined range in the longitudinal direction. Note that, in FIG. 9, the state in which the second displacement portion 14 is disposed at the neutral position P2 is illustrated by the solid lines, and position P2FR, at which the second displacement portion 14 is tilted furthest toward the front side, and position P2RR, at which the second displacement portion 14 is tilted furthest toward the rear side, are illustrated by the two-dot chain lines, respectively.

The first locking portion 16 is, as an example, provided integrally with the tilting mechanism provided at the base portion 26. This first locking portion 16 can be switched to two states that are a permitting state and a restricting state by, as an example, the electrification thereof being switched, or the like. Further, at the time when the first locking portion 16 is in the permitting state, tilting of the first displacement portion 12 is permitted. On the other hand, at the time when the first locking portion 16 is in the restricting state, tilting of the first displacement portion 12 is restricted. Note that the switching between the permitting state and the restricting state of the first locking portion 16 may be switching by a mechanical structure and not an electrical structure.

The second locking portion 18 is, as an example, provided integrally with the tilting mechanism that can tilt the second displacement portion 14 with respect to the first displacement portion 12. This second locking portion 18 can be switched to two states that are a permitting state and a restricting state by, as an example, the electrification thereof being switched, or the like. Further, at the time when the second locking portion 18 is in the permitting state, tilting of the second displacement portion 14 with respect to the first displacement portion 12 is permitted. On the other hand, at the time when the second locking portion 18 is in the restricting state, tilting of the second displacement portion 14 with respect to the first displacement portion 12 is restricted. Note that the switching between the permitting state and the restricting state of the second locking portion 18 may be switching by a mechanical structure and not an electrical structure.

### Operation and Effects of Present Embodiment

Operation and effects of the present embodiment are described next.

As an example, the above-described operation device 24 relating to the present embodiment can be applied to the following operation.

As illustrated in FIG. 8, in a case in which the mode of the vehicle is a first mode, the first locking portion 16 is in the permitting state, and the second locking portion 18 is in the restricting state. Here, the first mode is the “usual shift mode”. In the first mode, tilting of the first displacement portion 12 is permitted, and tilting of the second displacement portion 14 from the neutral position P2 is restricted. Further, in a case in which the mode of the vehicle is the first mode, the occupant of the vehicle can tilt the first displacement portion 12 in a state of gripping the second displacement portion 14. As an example, in the state in which the first displacement portion 12 is disposed at the position P1FR at which it is tilted furthest toward the front side, the transmission of the vehicle is in the parking state, and traveling of the vehicle is impossible. Further, in the state in which the first displacement portion 12 is disposed at the neutral position P1, the transmission of the vehicle is in a state in which forward advancing is possible, and the vehicle can advance forward. Moreover, in the state in which the first displacement portion 12 is disposed at the position P1RR at which it is tilted furthest toward the rear side, the transmission of the vehicle is in the state in which reversing is possible, and the vehicle can be reversed.

As illustrated in FIG. 9, in a case in which the mode of the vehicle is the second mode, the first locking portion 16 is in the restricting state, and the second locking portion 18 is in the permitting state. Here, the second mode is a “sport mode”. Note that the switching between the above-described first mode and second mode is switching by an unillustrated switching switch. In the second mode, tilting of the first displacement portion 12 from the neutral position P1 is restricted, and tilting of the second displacement portion 14 with respect to the first displacement portion 12 is permitted. Further, in a case in which the mode of the vehicle is the second mode, the occupant of the vehicle can tilt the second displacement portion 14 with respect to the first displacement portion 12 in a state of gripping the second displacement portion 14. As an example, in the state in which the first displacement portion 12 is disposed at the neutral position P1 and the vehicle is advancing forward, the mode of the vehicle is the second mode. Then, when the second displacement portion 14 is tilted from the neutral position P2 to the position P2FR at which it is tilted furthest toward the front side, the transmission of the vehicle is shifted up to a higher gear ratio than that at the time of that operation. Further, when the second displacement portion 14 is tilted from the neutral position P2 to the position P2RR at which it is tilted furthest toward the rear side, the transmission of the vehicle is shifted down to a lower gear ratio than that at the time of that operation.

### Operation Device Relating to Fourth Embodiment

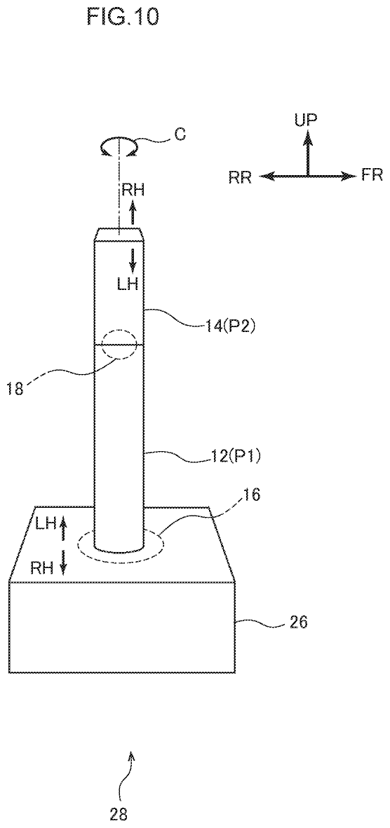

An operation device 28 relating to a fourth embodiment of the present invention is described next by using FIG. 10. Note that, at the operation device 28 relating to the fourth embodiment, members and portions corresponding to the operation device 24 of the above-described third embodiment are denoted by the same reference numerals as the members and portions corresponding to the operation device 24 relating to the third embodiment, and there are cases in which description thereof is omitted.

As illustrated in FIG. 10, at the operation device 28 of the present embodiment, the second displacement portion 14 is supported so as to be able to rotate with respect to the first displacement portion 12. Specifically, the second displacement portion 14 is supported at the upper end portion of the first displacement portion 12 via an unillustrated rotating mechanism so as to be able to rotate in a predetermined range in the left-right directions (the arrow C directions) with the vertical direction being the axial direction thereof. Note that FIG. 9 illustrates a state in which the second displacement portion 14 is disposed at the neutral position P2.

In the above-described operation device 28 of the present embodiment, in a case in which the mode of the vehicle is the second mode, the first locking portion 16 is in the restricting state, and the second locking portion 18 is in the permitting state. In this state, the occupant of the vehicle can rotate the second displacement portion 14 left and right with respect to the first displacement portion 12. As an example, in the state in which the first displacement portion 12 is disposed at the neutral position P1 and the vehicle is advancing forward, the mode of the vehicle is the second mode. Further, when the second displacement portion 14 is tilted from the neutral position P2 to the position at which it is tilted furthest toward the right side, the transmission of the vehicle is shifted up to a higher gear ratio than that at the time of that operation. Further, when the second displacement portion 14 is tilted from the neutral position P2 to the position at which it is tilted furthest toward the left side, the transmission of the vehicle is shifted down to a lower gear ratio than that at the time of that operation.

The operation devices 10, 22, 24, 28 of the above respective embodiments have been described, and plural modes of the vehicle can be handled in accordance with the operation devices 10, 22, 24, 28 of these respective embodiments.

Note that, although examples have been described in which the operation devices 10, 22 relating to the first embodiment and the second embodiment are used as operation devices that carry out operations for changing the orientation and the position of a vehicle, the present invention is not limited to this. For example, the operation devices 10, 22 relating to the first embodiment and the second embodiment may be used as operation devices that carry out operations for shifting gears or the like such as in the operation devices 24, 28 relating to the third embodiment and the fourth embodiment. Further, the operation devices 10, 22 relating to the first embodiment and the second embodiment may be used as operation devices that carny out operations for shifting gears or the like such as in the operation devices 24, 28 relating to the third embodiment and the fourth embodiment. Further, the structures of the respective embodiments may be combined together.

Although embodiments of the present invention have been described above, the present invention is not limited to the above, and, of course, can be implemented by being modified in various ways other than the above, within a scope that does not depart from the gist thereof.

The disclosure of Japanese Patent Application No. 2020-023424 filed on Feb. 14, 2020 is, in its entirety, incorporated by reference into the present specification.

1. An operation device comprising:
a first displacement portion that is displaceable by being operated by an occupant of a vehicle;
a second displacement portion that is supported at the first displacement portion, and is displaceable with respect to the first displacement portion by being operated by an occupant of the vehicle; and
a locking portion that, at a time when a mode of the vehicle is a first mode, permits displacement of the first displacement portion and restricts displacement of the second displacement portion with respect to the first displacement portion, and, at a time when the mode of the vehicle is a second mode, restricts displacement of the first displacement portion and permits displacement of the second displacement portion with respect to the first displacement portion.

2. The operation device of claim 1, wherein:
the first displacement portion is rotatably supported, and
the second displacement portion is tiltably supported at the first displacement portion.

3. The operation device of claim 1, wherein:
the first displacement portion is tiltably supported, and
the second displacement portion is tiltably supported at the first displacement portion.

4. The operation device of claim 1, wherein the second displacement portion is rotatably supported at the first displacement portion.

5. The operation device of claim 2, wherein:
a pair of second displacement portions are supported at the first displacement portion respectively, and
at the time when the mode of the vehicle is the second mode, the locking portion permits displacement of the pair of second displacement portions in a same direction.

6. The operation device of claim 2, wherein:
a pair of second displacement portions are supported at the first displacement portion respectively, and
at the time when the mode of the vehicle is the second mode, the locking portion permits displacement of the pair of second displacement portions in directions different from one another.
